(19) United States
(12) Patent Application Publication
(10) Pub. No.: US 2009/0282140 A1
(43) Pub. Date: Nov. 12, 2009

(54) Method and system for server location tracking

(75) Inventors: Christopher White, Redmond, WA (US); William Hunter, Bothell, WA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., BURBANK, CA (US)

(21) Appl. No.: 12/151,876

(22) Filed: May 9, 2008

(51) Int. Cl. G06F 15/173

(52) U.S. Cl. 709/223

(57) ABSTRACT

There is provided a method of locating a first server coupled to a network of servers in a data center having a plurality of servers including the first server, the network including a data center management computer. The method comprises obtaining, by a first server, an identification data from a locator coupled to the server, wherein the identification data can be utilized to determine a location of the locator in the data center; storing the identification data in a memory of the first server; and providing, by the first server, an information based on the identification data to the data center management computer.

### BACKGROUND OF THE INVENTION

1. Field of the Invention

The present invention is generally in the field of server management. More particularly, the present invention relates to automatically tracking the location of servers.

2. Background Art

As computer networks, such as the Internet, have grown in size and bandwidth, the demand such networks place on servers has grown in proportion. As a consequence, large collections of servers are typically pooled in data centers to take advantage of economies of scale and for convenience of management. In modern practice, for example, a data center can occupy a large warehouse and can include thousands of servers in hundreds of racks. The practice of managing such large numbers of servers involves several challenges.

One major challenge is tracking the location of individual servers in the data center. Typically, when a server requires maintenance, a technician must be dispatched to the particular rack where the server is located. To keep track of the server locations for this purpose, one conventional solution requires the technician to manually note where each server is maintained, e.g. when installed or removed. Such manual solutions are error-prone, because they require human data entry.

Another conventional solution applies an RFID tag to each server that can be read by antennas on each rack. While this conventional solution allows for semi-automated tracking of server locations in the data center, technicians must initially manually associate each RFID tag with its respective server in person, which is also error-prone as in the first conventional solution.

Thus, there is a need in the art for a solution to the problem of server location tracking that overcomes the drawbacks associated with the conventional solutions.

### SUMMARY OF THE INVENTION

A method and system for server location tracking, substantially as shown in and/or described in connection with at least one of the figures, and as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for server location tracking, according to one embodiment of the present invention; and

FIG. 2 is a flowchart presenting a method for server location tracking, according to one embodiment of the present invention.

### DETAILED DESCRIPTION OF THE INVENTION

The present invention is directed to a method and system for server location tracking. Although the invention is described with respect to specific embodiments, the principles of the invention, as defined by the claims appended herein, can obviously be applied beyond the specific embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

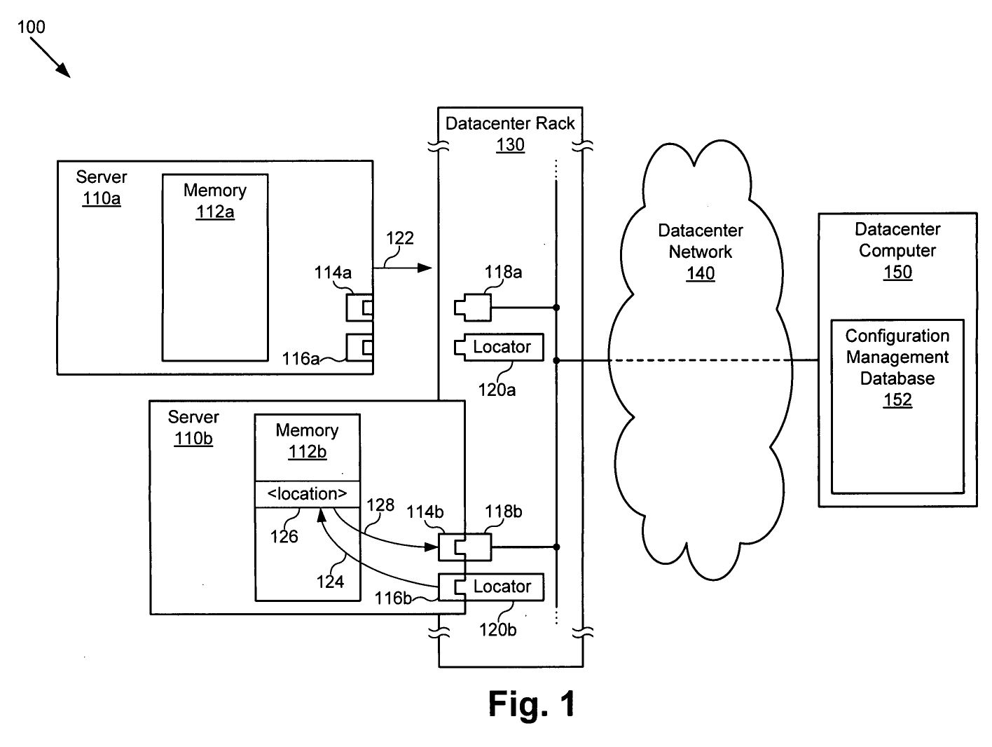

FIG. 1 shows exemplary system 100 for server location tracking according to one embodiment of the present invention. System 100 comprises server 110a, server 110b, data center rack 130, data center network 140, and data center computer 150. Server 110a comprises a processor (not shown), memory 112a, network socket 114a, and locator socket 116a, and server 110b comprises a processor (not shown), memory 112b, network socket 114b, and locator socket 116b. Data center rack 130 comprises network plug 118a, locator 120a, network plug 118b, and locator 120b. Server 110a is shown in an uninstalled configuration with respect to data center rack 130, while server 110b is shown in an installed configuration.

Servers 110a and 110b are in this embodiment of the invention rack-mountable computers designed for installation in data center rack 130. The processors of servers 110a and 110b are typical microprocessors, and memories 112a and 112b comprise typical RAM (“Random Access Memory”) components. Data center rack 130 has been designed to rack-mount a plurality of servers, e.g. server 110a, server 110b, and additional servers not shown. While server 110b is shown rack-mounted in data center rack 130, server 110a is not yet installed. In transaction 122, a technician may rack-mount server 110a by physically attaching server 110a to data center rack 130 and coupling server 110a to a power source (not shown). The technician also couples network plug 118a to network socket 114a, and couples locator 120a to locator socket or connector 116a and thus physically attaching locator 120a to the data center rack 130. Once transaction 122 has been completed, server 110a is installed in data center rack 130 in a manner similar to server 110b.

In this embodiment of the present invention, network plugs 118a and 118b and network sockets 114a and 114b are Ethernet connectors, and data center network 140 is an Ethernet-based network. In other embodiments the network plugs and sockets utilized by the servers and the data center rack, and the network utilized by the data center network, could be based on a different network technology, e.g. fiber channel. The network plugs and sockets in system 100 serve to couple servers 110a and 110b to data center computer 150 via data center rack 130 and data center network 140 for server management purposes. Additional servers in additional data center racks that are not shown may also be coupled via data center network 140 to data center computer 150.

In this embodiment of the present invention, locators 120a and 120b and locator sockets 116a and 116b are USB (“Universal Serial Bus”) devices. In particular, locator sockets 116a and 116b are USB sockets coupled to the respective processor and memory 112a or 112b of servers 110a and 110b. Locators 120a and 120b comprise non-volatile flash memories with USB plugs, i.e. comprise flash-memory USB fobs. In other embodiments the locators and locator sockets utilized by the servers and the data center rack could communicate via a different wired protocol, e.g. Firewire, or via a wireless protocol, e.g. on a Bluetooth or RFID (“Radio Frequency Identification”) protocol. Additionally, in other embodiments utilizing a wired USB protocol, instead of comprising flash-memory USB fobs locators 120a and 120b could be implemented, for example, as USB cables connected to a shared USB device configured to communicate with both servers 110a and 110b via locator sockets 116a and 116b. In such an embodiment, one such shared USB device on data center rack 130 could be coupled via USB cable, for example, to every server on data center rack 130, including servers 110a and 110b.

The flash memories of locators 120a and 120b are programmed with the respective locations on data center rack 130 where locators 120a and 120b are attached. In this embodiment, the respective locations are represented by unique serial numbers. For example, in one embodiment, data center rack 130 has a capacity for 32 servers, and servers 110a and 110b are installed in the central two locations in data center rack 130, and therefore locators 120a and 120b are programmed with, for example, locations 16 and 17. In embodiments of system 100 having second and third data center racks, those might be configured, for example, with locations 33 through 64 and 65 through 96. Other embodiments of the invention may use different location numbering schemes, so long as each location is programmed into a respective locator. In this embodiment of the invention, the flash memories of locators 120a and 120b are programmed by configuring the flash memories to store files containing location serial numbers. In other embodiments, the locations may be stored in a different configuration, e.g. by storing the location as a file name in the flash memory, or by configuring the flash memory to operate without a file system.

Locators 120a and 120b are attached to data center rack 130 in locations where servers 110a and 110b will be installed. In this embodiment, locators 120a and 120b, being flash-memory USB fobs, are attached to data center rack 130 with connectors, e.g. with cords. In such embodiment, the cords are sufficiently long so that locators 120a and 120b can reach locator sockets 116a and 116b when servers 110a and 110b are installed. In an embodiment utilizing USB cables for locators 120a and 120b, the USB cables must have a similar length. In an embodiment utilizing a wireless protocol, e.g. where locator sockets 116a and 116b comprise wireless receivers, locators 120a and 120b are wireless transmitters or transponders mounted on data center rack 130 in a manner conducive to accurate location resolution by each individual server. For example, if locator socket 116a is implemented as an RFID receiver, locator 120a should be implemented as an RFID tag attached to data center rack 130 in a location where server 110a can distinguish locator 120a from locator 120b and other locators. In such embodiment, locator 120a can communicatively connect to server 110a using an RFID-based communication channel.

The operation of system 100 can be illustrated by reference to server 110b. Server 110b, shown installed in data center rack 130, can perform transactions 124 and 128 to obtain and transmit location 126, which is initially programmed into locator 120b. After installation, during transaction 124, a software agent being executed on the processor of server 110b retrieves location 126 from the flash memory of locator 120b via locator socket 116b, and stores location 126 in memory 112b. In such embodiment, locator 120b can communicatively connect to server 110b using a USB-based communication channel. Subsequently, during transaction 128, the software agent of server 110b can transmit location 126 through network socket 114b via data center rack 130 and data center network 140 to configuration management database 152 executing on data center computer 150.

Configuration management database 152 thus tracks the location of server 110b automatically, without requiring manual input or human data entry. During further operation of system 100, if server 110b is subsequently removed from data center rack 130 and installed in a different location of data center rack 130, or in a different data center rack altogether, transactions 124 and 128 can be repeated with the appropriate proximate locator. Configuration management database 152 will thereby be updated again without manual input or human data entry, and server 110b will be tracked at the new location. Each additional server of system 100 including server 110a can be tracked in a similar manner, so that, for example, configuration management database 152 simultaneously tracks every server of system 100.

In one embodiment of the present invention, the operation of a locator, e.g. locator 120a, in the data center of system 100 can be further enhanced by including a display or signaling capability. For example, locator 120a may comprise an LED (“Light Emitting Diode”), a plurality of LEDs, or an LCD (“Liquid Crystal Display”) screen. In an embodiment wherein locator 120a comprises an LED, after server 110a is installed in data center rack 130, the software agent being executed on server 110a may manipulate the LED to signal, for example, status conditions of server 110a. Furthermore, data center computer 150 may manipulate the LED of locator 120a via data center network 140 and data center rack 130. For example, if server 110a reports an error condition to data center computer 150, a technician can be dispatched to the location of server 110a, and data center computer 150 can manipulate the LED of locator 120a to aide the technician in visually spotting server 110a.

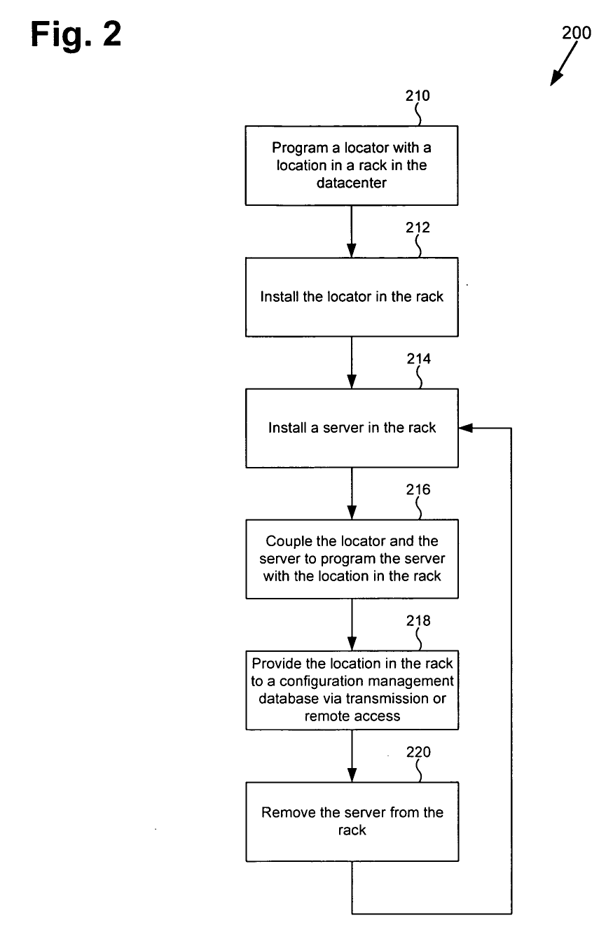

FIG. 2 shows flowchart 200 of an exemplary method for server location tracking, according to one embodiment of the present invention. Certain details and features have been left out of flowchart 200 that are apparent to a person of ordinary skill in the art. For example, a step may comprise one or more substeps or may involve specialized equipment or materials, as known in the art. While steps 210 through 220 indicated in flowchart 200 are sufficient to describe one embodiment of the present invention, other embodiments of the invention may utilize steps different from those shown in flowchart 200.

In step 210 of flowchart 200, a locator, for example locator 120a in FIG. 1, is programmed with a location in a rack in a data center, such as a location in data center rack 130 in the data center of system 100. The locator is a USB (“Universal Serial Bus”) device comprising a non-volatile flash memory with a USB plug, i.e. comprising a flash-memory USB fob. In other embodiments, the locator could communicate via a different wired protocol, e.g. Firewire, or via a wireless protocol, e.g. on a Bluetooth or RFID (“Radio Frequency Identification”) protocol. Additionally, in other embodiments, instead of comprising flash-memory USB fobs, the locator could be implemented, for example, as a USB cable connected to a shared USB device configured to be programmed with a plurality of locations in the rack. In the present embodiment, the location in the rack is represented by an identification data, e.g. serial number or location information, and the locator is programmed by storing the information or a file containing the information in the flash memory of the locator, where the information can be utilized to determine the location of the locator in the data center. In other embodiments, the location may be stored in a different manner, e.g. by storing the location as a file name in the flash memory, or by configuring the flash memory to operate without a file system, such dip switches indicative of the identification data.

In step 212 of flowchart 200, the locator is installed at the location in the rack. The rack in this embodiment is designed to rack-mount a plurality of servers, and thus has a plurality of locations. In this embodiment, the locator is attached to the rack with a connector, e.g. a cord, sufficiently long so that the locator can reach a locator socket, e.g. a USB socket such as locator socket 116a, of a server such as server 110a in FIG. 1, when the server is also installed in the rack. In an embodiment utilizing a USB cable for the locator, the USB cable must have a similar length. In all embodiments of the invention featuring locators implemented with wired protocols, the locators should be installed at locations in the rack so that they may be connected only to a server in a unique location, i.e. so that they may not be cross-coupled to an incorrect server.

In one embodiment of the invention, the locator is not installed by physically attaching the locator to the rack. Instead, the locator has, for example, a printed identifier and is stored in a container at the location in the rack that has an identical or similar printed identifier. In such an embodiment, when the server is installed, a technician may, for example, remove the locator from the container and couple the locator to the locator socket of the server, after ensuring that the printed identifiers on the container and the locator match. Subsequently, when the server is removed, the technician may remove the locator from the server and replace the locator in the container in the location, such that the locator is ready to be utilized during the next server installation.

In an embodiment of the invention utilizing a wireless protocol, e.g. where the locator socket of the server comprises a wireless receiver, the locator may be a wireless transmitter or transponder attached to the rack in a manner conducive to accurate location resolution by the server. For example, if the locator socket of the server is implemented as an RFID receiver, the locator may be implemented as an RFID tag attached to the rack in a location where the server can wirelessly distinguish the locator from other locators. The server may receive signals from multiple locators, but can determine a unique location in the rack by, for example, selecting the locator with the greatest signal strength.

In step 214 of flowchart 200, the server is installed at the location in the rack. As discussed above, the server has a locator socket configured to couple with the locator that is also installed at the location in the rack. In some embodiments, the locator socket and locator couple utilizing a wired protocol, while in other embodiments a wireless protocol is utilized. In this embodiment of the invention, the server additionally comprises a processor, a memory, and a network socket, and is a rack-mountable computer designed for installation in the rack. The processor of the server is a typical microprocessor, and the memory comprises typical RAM (“Random Access Memory”) components. The server is installed by a technician by physically attaching the server to the rack and connecting the server to a power source.

Additionally, the technician couples the network socket of the server to a data center network such as data center network 140 in system 100. In this embodiment of the present invention, the data center network is an Ethernet network, while in other embodiments the data center network could be based on a different network technology, e.g. fiber channel. The server is coupled via the data center network to a data center computer, such as data center computer 150, that is executing a configuration management database such as configuration management database 152.

In step 216 of flowchart 200, the locator and server are coupled to program the server with the location in the rack. In embodiments utilizing a wired protocol, this step is performed by the technician after installing the server in the rack in step 214. In embodiments using a wireless protocol, the technician may be absent after installing the server in step 214 when, in step 216, the wireless locator socket and locator actually couple. In both embodiments, after the server and locator couple, a software agent being executed on the processor of the server can retrieve the identification information from the locator and store the identification information in the memory of the server, in a transaction similar to transaction 124. The server is thus programmed with the location in the rack.

In step 218 of flowchart 200, the server provides the identification information in the rack to the configuration management database in the network. In one embodiment, this is accomplished by the software agent which operated during step 216, and which now operates to transfer the identification information from the memory of the server via the network to the data center management computer. In another embodiment, the memory containing the identification information may be made accessible via the network, such that the identification information can be retrieved using a remote access scheme. Consequently, the configuration management database can track the location of the server automatically without requiring manual input or human data entry. In one embodiment, the server may determine its location based on the identification information and transmit its location to the data center. In other embodiments, the server may transmit the identification data to the data center management computer for mapping the identification data to the location of the locator.

In step 220 of flowchart 200, the server is removed from the rack. A technician first locates the server by utilizing the configuration management database. The technician may instruct the server, via the configuration management database, to manipulate an LED of the locator coupled to the server to aide the technician in finding the server, as discussed above in FIG. 1. After finding the server, to remove the server the technician decouples the locator from the locator socket (in embodiments utilizing wired protocols) and decouples the network socket from the network. The technician continues by decoupling the power source and physically removing the server from the rack. Subsequently, the server may be relocated to a new location in the rack or another rack. Should this occur, flowchart 200 loops back to step 214 to repeat the steps of server installation for the new location.

In the manner described above, the invention as shown in exemplary system 100 and flowchart 200 achieves server location tracking and overcomes major drawbacks of conventional solutions. Server locations in, for example, a data center are tracked by, for example, the innovative use of locators, which are programmed with locations and attached to data center racks. The drawbacks of conventional solutions, which often require human data entry and are thus error-prone, are avoided. By utilizing an embodiment of the present invention, no manual association of servers with location information needs to be performed. Instead, programmed locators are simply coupled to servers when installed, and decoupled from servers when removed, thereby enabling a configuration management database, for example, to perform server location tracking.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method of locating a first server coupled to a network of servers in a data center having a plurality of servers including the first server, the network including a data center management computer, the method comprising:
obtaining, by a first server, an identification data from a locator coupled to the server, wherein the identification data can be utilized to determine a location of the locator in the data center;
storing the identification data in a memory of the first server; and
providing, by the first server, an information based on the identification data to the data center management computer.

2. The method of claim 1, wherein the information is the identification data.

3. The method of claim 1, wherein the information is indicative of a location of the locator.

4. The method of claim 1, wherein the identification data is a unique serial number associated with the locator.

5. The method of claim 1, wherein the identification data indicates the location of the locator in the data center.

6. The method of claim 1, wherein the providing includes making the identification data in the memory accessible via the network.

7. The method of claim 1, the providing includes transmitting information based on the identification data to the data center management computer.

8. The method of claim 1, wherein the locator comprises a USB device, and wherein the locator comprises a USB cable coupled to the USB device configured to be programmed with a plurality of locations in the data center.

9. The method of claim 1, wherein the locator comprises an RFID tag configured to interface with an RFID reader of the server.

10. The method of claim 1, wherein the location in the data center is programmed into the locator using the indemnification data having a unique serial number.

11. A first server for coupling to a network of servers in a data center having a plurality of servers including the first server, the network including a data center management computer, the first server comprising:
a processor configured to obtain an identification data from a locator, wherein the identification data can be utilized to determine a location of the locator in the data center;
a memory configured to store the identification data; and
the first server further configured to provide an information based on the identification data to the data center management computer.

12. The first server of claim 11, wherein the information is the identification data.

13. The first server of claim 11, wherein the information is indicative of a location of the locator.

14. The first server of claim 11, wherein the identification data is a unique serial number associated with the locator.

15. The first server of claim 11, wherein the identification data indicates the location of the locator in the data center.

16. The first server of claim 11 further configured to provide the information to the data center management computer by making the identification data in the memory accessible via the network or transmitting the information to the data center management computer.

17. A locator for coupling to a first server in a network of servers in a data center having a plurality of servers including the first server, the network including a data center management computer, the locator comprising:
a memory configured to store identification information indicative of a location of the locator in the data center;
a first connector for physically attaching the locator to a rack in the data center; and
a second connector for communicatively connecting the locator to the first server.

18. The locator of claim 17, wherein the second connector comprises a USB device, and wherein the locator further comprises a USB cable coupled to the USB device configured to be programmed with the identification information.

19. The locator of claim 17, wherein the second connector comprises an RFID tag configured to interface with an RFID reader of the first server.

20. The locator of claim 17, wherein the location in the data center is programmed into the locator using the indemnification data having a unique serial number.
